(19) United States
(12) Patent Application Publication
(10) Pub. No.: US 2024/0343298 A1
(43) Pub. Date: Oct. 17, 2024

(54) STEERING SYSTEM FOR A VEHICLE HAVING A STEERING ELEMENT AND STEER-BY-WIRE STEERING HAVING SUCH A STEERING SYSTEM

(71) Applicant: ZF Automotive Germany GmbH, Alfdorf (DE)

(72) Inventor: Ian BLÄSER, Bochum (DE)

(21) Appl. No.: 18/633,888

(22) Filed: Apr. 12, 2024

(30) Foreign Application Priority Data
Apr. 14, 2023 (DE) 102023203408.5

(51) Int. Cl. B62D 5/04; B62D 5/00

(52) U.S. Cl. CPC B62D 5/0481; B62D 5/001; B62D 5/0442

(57) ABSTRACT

The disclosure relates to a steering system for a vehicle having a steering element. The steering element is linearly displaceable in a longitudinal direction of a central longitudinal axis of the steering element. A detection device for detecting a position of the steering element is also provided, the detection device having at least one rack section extending parallel to the central longitudinal axis. The rack section is linearly displaceable together with the steering element and the detection device has at least one detection gear wheel and a permanent magnet is fastened to the detection gear wheel. To be able to implement a compact and/or cost-efficient design and/or a true-power-on function, the detection gear wheel engages in the rack section.

### CROSS-REFERENCE TO RELATED APPLICATION

This application claims priority to German Priority Application No. 10/202,3203408.5, filed Apr. 14, 2023, the disclosure of which is incorporated herein by reference in its entirety.

### TECHNICAL FIELD

The disclosure relates generally to a steering system for a vehicle having a steering element, wherein the steering element is linearly displaceable in the longitudinal direction of a central longitudinal axis of the steering element, and having a detection device for detecting a position of the steering element. The disclosure also relates to steer-by-wire steering having such a steering system.

### BACKGROUND

Such a steering system is known from DE 20 2022 103 825 U1. For example, it is known to have a spur gear engaged in a rack section, wherein the spur gear in turn transmits its rotational movement to a detection gear wheel which has a permanent magnet.

More specifically, such a steering system for adjusting a steering angle on wheels of the vehicle provides a drive motor which displaces the steering element, for example a steering rod.

In steer-by-wire steering, there is no mechanical connection between a steering handle, for example a steering wheel, and the steering rod. The position of the steering handle is electronically detected and a corresponding displacement of the steering rod is achieved by a drive motor.

In electrical servo steering systems, although there is a mechanical connection between the steering handle and the steering rod, the displacement of the steering rod is likewise here assisted by a drive motor.

To determine the steering angle, there can be sensors for detecting the steering angle using a position of the steering element.

According to a known variant, to determine the steering angle there are two rotational angle sensors which, for example, are based on a magnetic, an inductive, a resistive or an optical operating principle. The rotational angle sensors have a different transmission ratio to a drive pinion, so that a phase difference is produced between the sensor signals, using which an absolute position of the drive pinion, i.e., a rotational position and a number of revolutions, can be determined.

The disadvantage with such systems is that two sensor circuits are required, since the rotational angles of two gear wheels must be detected in order to be able to determine the steering angle unambiguously. As a result, this solution entails high costs. Furthermore, in such systems the production tolerances have a direct influence on the sensor signals and therefore on the steering angle determined, so that the system must be produced with high accuracy.

In a further known variant, a rotational angle sensor is provided in combination with an index sensor which can detect a number of revolutions of a drive pinion. In operation, a rotational angle signal over 360° and an index signal are output, a control unit counting the complete revolutions of the drive pinion using the signal from the index sensor. The disadvantage with rotational angle sensors with index sensors is that no absolute position can independently be supplied thereby when starting the vehicle, instead that access must be made to a store in the control unit. When the vehicle is switched off, the control device must store the index value in order to be able to determine the correct steering angle at the next start. However, this carries the risk that the control unit loses the value or the latter changes, which would lead to a false absolute position in the steering. Thus, such sensors cannot provide a guaranteed true-power-on function. A true-power-on function means that an absolute steering angle can be determined unambiguously solely using the sensor signals when the vehicle restarts.

### SUMMARY

What is needed is to further develop a steering system and/or steer-by-wire steering of the type mentioned at the beginning in such a way that a compact and/or inexpensive design can be realized. In one exemplary arrangement, a true-power-on function should be realizable.

A steering system according to the disclosure is designed for a vehicle, for example for a motor vehicle. The steering system has a steering element. The steering element may be designed as a steering rod or a chassis link or a track rod. The steering element is linearly displaceable in a longitudinal direction of a central longitudinal axis of the steering element. For example, the steering element is displacable by a drive motor. To this end, the drive motor can be connected by a gear mechanism, such as a belt gear mechanism or spindle gear mechanism or worm gear mechanism.

Further, the steering system has a detection device for detecting a position of the steering element. For example, a relative position of the steering element in relation to a housing can be detected and/or determined by the detection device. The steering element can be displaceably arranged and/or mounted within the housing. In one exemplary arrangement, the steering element projects with at least one end out of the housing. The steering element can be connected directly or indirectly to at least one wheel and for steering the wheel.

The detection device has at least one rack section extending parallel to the central longitudinal axis. For example, the rack section has a row of teeth on an outer side. Here, the rack section is linearly displaceable together with the steering element. In one exemplary arrangement, a single rack section or a maximum of two rack sections is/are provided.

Further, the detection device has at least one detection gear wheel. A permanent magnet is fastened to this detection gear wheel. Thus, the permanent magnet is co-rotated during a rotational movement of the detection gear wheel. At least teeth of the detection gear wheel and teeth of the rack section can be manufactured from the same material, for example, plastic. In this way, identical temperature characteristics and/or low wear can be achieved. According to the disclosure, the detection gear wheel engages in the rack section.

It is advantageous here that the detection gear wheel having the permanent magnet is thus in toothed engagement immediately or directly with the rack section. Thus, for example, it is possible to dispense with an additional spur gear between the detection gear wheel and the rack section. A more compact design is thus made possible. Since the number of components is or can be reduced, the manufacture can additionally be carried out more economically. In addition, a higher measurement accuracy can be achieved on account of a lower tolerance chain.

For example, the steering element is displaceable relative to the detection gear wheel. Together with the steering element, the rack section is displaceable relative to the detection gear wheel, wherein the detection gear wheel engaging in the rack section is set into a rotational movement or rotation because of the displacement of the steering element and of the rack section.

The detection device can have a magnetic sensor for detecting the rotational position of the detection gear wheel and a rotation counter for detecting a number of revolutions of the detection gear wheel. In one exemplary arrangement, the magnetic sensor and the rotation counter are arranged and/or embedded in a common IC or integrated circuit.

For example, an absolute position of the steering element can be determined unambiguously by the magnetic sensor and the rotation counter. A steering angle on a wheel of the vehicle can be determined unambiguously thereby. Since both a rotational position of the detection gear wheel relative to 360° can be determined by the magnetic sensor, and also a number of revolutions of the detection gear wheel can be determined by the rotation counter, a true-power-on function is ensured.

Because of the detection gear wheel with the permanent magnet engaging directly in the rack section, production tolerances have only a slight influence on the detected sensor signals, so that an absolute position of the steering element can be determined with high accuracy.

In one exemplary arrangement, the rotation counter is based on the operating principle of magnetoresistance. In practical terms, the rotation counter can comprise an electrically and magnetic conductive structure which changes its resistance value on the basis of being influenced by an external rotating magnetic field, for example the permanent magnet of the detection gear wheel. The resistance values can be used as a code for a current number of revolutions. More precisely, the number of revolutions can be inferred using a resistance value from the rotation counter.

For example, the rotation counter is based on the use of what are known as domain walls, which are displaced under the influence of the rotating magnetic field of the permanent magnet. A domain wall is an interface which separates magnetic domains. In other words, a domain wall is a transition between different magnetic moments.

The electrically and magnetic conductive structure can be designed in the form of a spiral, a detectable number of revolutions being determined using the number of windings. The more windings there are, the more revolutions can be counted.

In one exemplary arrangement, the number of revolutions is counted relative to a starting position. This means that with increasing deflection of the steering element, the number of counted revolutions of the detection gear wheel increases. If the steering element is moved back into a neutral position, the number of counted revolutions decreases again. This principle applies equally to a deflection in both directions.

In one exemplary arrangement, the detection gear wheel and/or the magnetic sensor and/or the rotation counter is assigned to a housing, the steering element being displaceable relative to the housing. The detection gear wheel and/or the magnetic sensor and/or the rotation counter can be fastened to the housing. In one exemplary arrangement, an axis of rotation of the detection gear wheel is connected to a housing. The axis of rotation of the detection gear wheel may be rotatably mounted on the housing.

According to a further exemplary arrangement, an evaluation unit and/or a control unit is connected to the detection device. With use of the evaluation unit and/or the control unit and using data signals obtained by the detection device, the position of the steering element is or can be determined here. For example, the data signals are provided by the magnetic sensor and the rotation counter. In one exemplary arrangement, the magnetic sensor and the rotation counter are integrated in a common circuit. If the magnetic sensor and the rotation counter are integrated in a common or single circuit, a compact design is achieved on account of a reduced number of electronic and magnetic components as compared with known solutions. As a result, the steering system can likewise be implemented particularly cost-effectively. The signal from the permanent magnet of the detection gear wheel is used here by two different sensors, i.e. by the magnetic sensor and the rotation counter, which means that the compact design can be realized.

The rack section can be designed as a one-piece constituent part of the steering element. To this end, the rack section can be machined out of a section of the steering element by a mechanical or material-removing processing. Alternatively, the rack section can be designed as an independent component, the rack section being fixedly connected to the steering element. For example, the rack section, as an independent component, is fastened to the steering element by at least one fastening arrangement or a plurality of fastening devices, for example, screws. Alternatively or in addition, the rack section can be connected to the steering element in an integral, force-fitting and/or form-fitting manner.

According to a development, the detection device has a first detection gear wheel with a first permanent magnet and a second detection gear wheel with a second permanent magnet. Depending on the actual design of the detection device, the use of two detection gear wheels can be used to implement the Vernier principle or to provide a redundancy function. For example, the first detection gear wheel and the second detection gear wheel are mounted in the housing so as to be rotatable relative to each other without contact, the steering element being linearly displaceable relative to the housing. The two detection gear wheels can be arranged relative to one another and/or spaced apart from one another in the axial direction and/or transversely with respect to the axial direction of the central longitudinal axis of the steering element. In one exemplary arrangement, the two detection gear wheels are designed as identical parts and/or with an identical external diameter. For example, the two detection gear wheels are manufactured from the same material, such as plastic.

For example, the first detection gear wheel and the second detection gear wheel engage in the same rack section at different positions. Thus, a single rack section is provided. This benefits a compact and component-saving design.

Alternatively, the first detection gear wheel can engage in a first rack section and the second detection gear wheel can engage in a second rack section formed independently of the first rack section. For example, the first rack section and the second rack section are arranged opposite each other and/or mirror-symmetrically relative to each other. In one exemplary arrangement, the two rack sections are spaced apart from each other transversely or at right angles to the central longitudinal axis of the steering element. The two detection gear wheels can be arranged between the two rack sections. For example, the two detection gear wheels rotate in different directions.

According to a further exemplary arrangement, to realize a redundancy, the first detection gear wheel is assigned a first magnetic sensor for detecting the rotational position of the first detection gear wheel and a first rotation counter for detecting a number of revolutions of the first detection gear wheel, and the second detection gear wheel is assigned a second magnetic sensor for detecting the rotational position of the second detection gear wheel and a second rotation counter for detecting a number of revolutions of the second detection gear wheel.

In an alternative arrangement, the Vernier principle is implemented by the first detection gear wheel and the second detection gear wheel. For this purpose, the first detection gear wheel is formed differently from the second detection gear wheel, for example with regard to its external diameter and/or the number of teeth.

According to a development, the at least one detection gear wheel is displaceably mounted transversely or at right angles to the central longitudinal axis of the steering element by a guide device in order to compensate for tolerances. In the case of a plurality of detection gear wheels, each detection gear wheel can be assigned such a guide device. For example, an axis of rotation of the detection gear wheel is linearly displaceably guided in at least one guide groove of the guide device. The guide groove can be aligned at right angles to the central longitudinal axis of the steering element and/or to the longitudinal extent of the rack section. The guide device can have a spring element, for example elastic spring element or a spring. In one exemplary arrangement, the detection gear wheel is preloaded and/or spring-mounted in the direction of the rack section by the spring element of the guide device. This ensures that the detection gear wheel is always in toothed engagement with the rack section. At the same time, tolerances, in particular material tolerances, production tolerances and/or wear tolerances, can be compensated.

According to a further exemplary arrangement, the at least one detection gear wheel and/or an axis of rotation of the detection gear wheel is rotatably mounted and/or guided in an at least one rotary holder. For example, the rotary holder is designed as a constituent part of a or the housing. In a design with a guide device, the guide groove can simultaneously form the rotary holder. The rotary holder has a segment-like or polygonal contour.

Steer-by-wire steering with a steering system according to the disclosure is of a particular advantage. In one exemplary arrangement, the steer-by-wire steering is further developed according to the configurations explained in connection with the steering system according to the disclosure described here.

### BRIEF DESCRIPTION OF DRAWINGS

The disclosure is described in more detail below with reference to the figures. Identical designations refer here to identical, similar or functionally identical components or elements, in which:

FIG. 1 shows a schematic sectioned side view of steer-by-wire steering according to the disclosure,

FIG. 2 shows a schematic perspective detail of a first steering system according to the disclosure,

FIG. 3 shows a schematic perspective detail of a second steering system according to the disclosure,

FIG. 4 shows a schematic perspective detail of a third steering system according to the disclosure,

FIG. 5 shows a schematic waveform of signals from sensors of a detection device for a steering system according to one of FIG. 2, 3 or 4,

FIG. 6 shows a schematic perspective detail of a fourth steering system according to the disclosure,

FIG. 7a shows a schematic top view of a fifth steering system according to the disclosure,

FIG. 7b shows a schematic top view of a sixth steering system according to the disclosure,

FIG. 8a shows a schematic top view of a seventh steering system according to the disclosure, and

FIG. 8b shows a schematic top view of a further steering system according to the disclosure.

### DETAILED DESCRIPTION

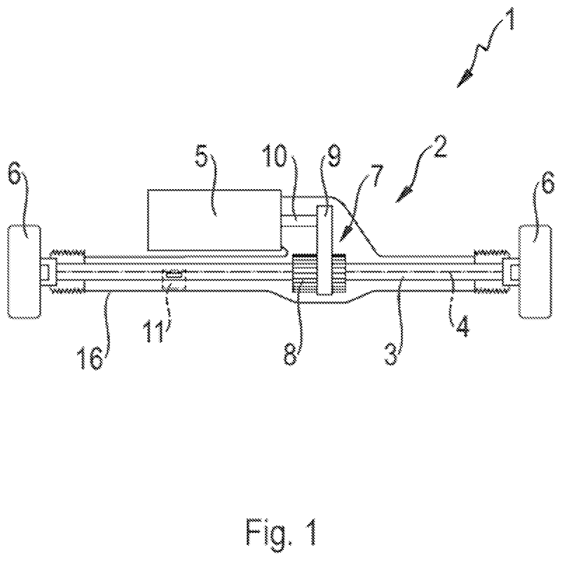

FIG. 1 shows a schematic sectioned side view of steer-by-wire steering 1 according to the disclosure for a vehicle not specifically illustrated here. The steer-by- wire steering 1 has a steering system 2 according to the disclosure.

The steering system 2 comprises a steering element 3, the steering element 3 in this exemplary arrangement being designed as a steering rod. The steering element 3 is linearly displaceable in the longitudinal direction of the steering element 3 or a central longitudinal axis 4 of the steering element 3.

A drive motor 5 is configured to displace the steering element 3 in order to adjust a steering angle at wheels 6 of the vehicle. For this purpose, the drive motor 5 is connected to the steering element 3 by a gear mechanism 7.

In this exemplary arrangement, the gear mechanism 7 is formed as a belt gear mechanism. For this purpose, a spindle nut 8 coupled to the steering element 3 is provided, which is rotatable to displace the steering element 3.

In practical terms the spindle nut 8 is rotatable by the drive motor 5, wherein the drive motor 5 is connected to the spindle nut 8 by a toothed belt 9, which in turn is in engagement with a motor shaft 10 of the drive motor 5 and the spindle nut 8.

In such steer-by-wire steering 1 or in such a steering system 2, it is desired to be able to determine a currently present steering angle at any time. This ensures that an electronically detected position of a steering handle, not specifically illustrated here, is or has been always converted correctly into a steering angle.

For this purpose, the steer-by-wire steering 1 or the steering system 2 has a detection device 11, merely indicated schematically here, for detecting a position of the steering element 3. Various exemplary arrangements of the detection device 11 are explained in more detail with reference to the following figures.

The detection device 11 in this exemplary arrangement is arranged inside a housing 16 of the steering system 2.

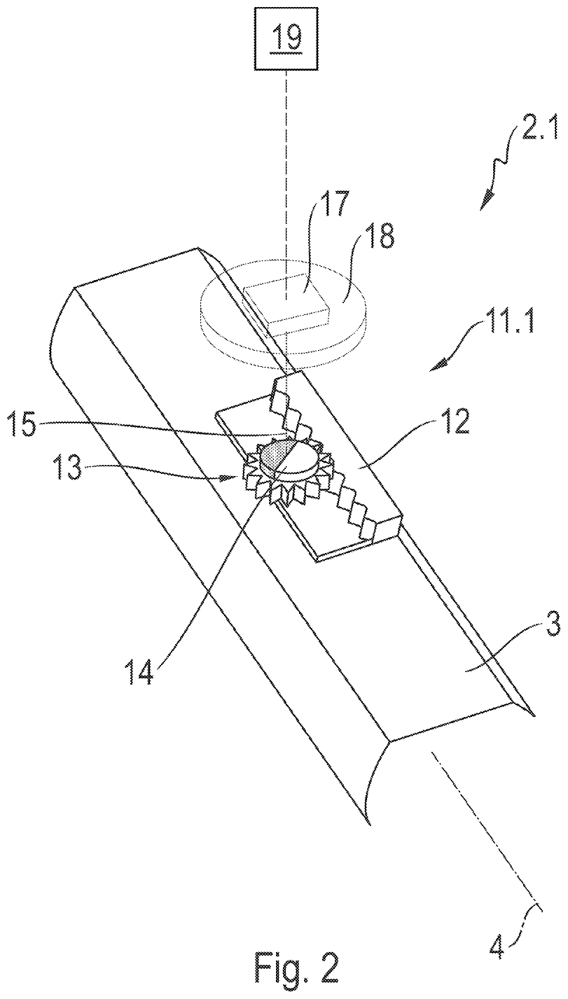

FIG. 2 shows a schematic perspective detail of a first steering system 2.1 according to the disclosure, for example for the steer-by-wire steering 1 according to FIG. 1. Only a detail of the steering element 3 and a schematic illustration of constituent parts of an arrangement of the detection device 11 are illustrated here.

The exemplary arrangement of the detection device 11.1 illustrated here has exactly one rack section 12 extending parallel to the central longitudinal axis 4. This rack section 12 is fastened to the steering element 3 and is therefore linearly displaceable together with the steering element 3. In this exemplary arrangement, the rack section 12 is formed as a component independent of the steering element 3, the rack section 12 preferably being integrally connected to the steering element 3. Alternatively, the rack section 12 can be formed as a one-piece or integral constituent part of the steering element 3.

The detection device 11.1 also has a detection gear wheel 13. A permanent magnet 14 is fastened to the detection gear wheel 13. The permanent magnet 14 is arranged here on the detection gear wheel 13 coaxially with an axis of rotation 15 of the latter. Thus, the permanent magnet 14 can rotate about the axis of rotation 15 together with the detection gear wheel 13.

The detection gear wheel 13 engages directly in the rack section 12. Thus, the detection gear wheel 13 is in toothed engagement directly with the rack section 12. This permits a compact design. Since the number of components can be reduced, the manufacture can additionally be realized more cost-effectively. In addition, a high measurement accuracy can be achieved.

The detection device 13 has a magnetic sensor 17 for detecting the rotational position of the detection gear wheel 13 and a rotation counter 18 for detecting a number of revolutions of the detection gear wheel 13. The sensor 17 and the rotation counter 18 are merely indicated schematically here.

Considering FIG. 1, the detection gear wheel 13, the sensor 17 and the rotation counter 18 are assigned to the housing 16 shown there, the steering element 3 being displaceable relative to the housing 16. The axis of rotation 15 of the detection gear wheel 13 is connected directly or indirectly to the housing 16. The rack section 12 is displaced relative to the detection gear wheel 13 together with the steering element 3. Because of this displacement of the steering element 2 and the gear wheel section 12, the detection gear wheel 13 engaging in the rack section 12 is set into a rotational movement or rotation about the axis of rotation 15.

In this exemplary arrangement, the magnetic sensor 17 and the rotation counter 18 are accommodated in a common integrated circuit. Thus, only a single so-called sensor IC is necessary, in which the sensor 17 and the rotation counter 18 are integrated as sensor elements. It is thus possible to dispense with the use and wiring of two individual sensor ICs, one sensor IC having the sensor 17, and a further sensor IC having the rotation counter 18.

A schematically indicated evaluation and control unit 19 is connected to the detection device 11.1, the position of the steering element 3 being determined by the evaluation and control unit 19 using data signals obtained from the magnetic sensor 17 and the rotation counter 18.

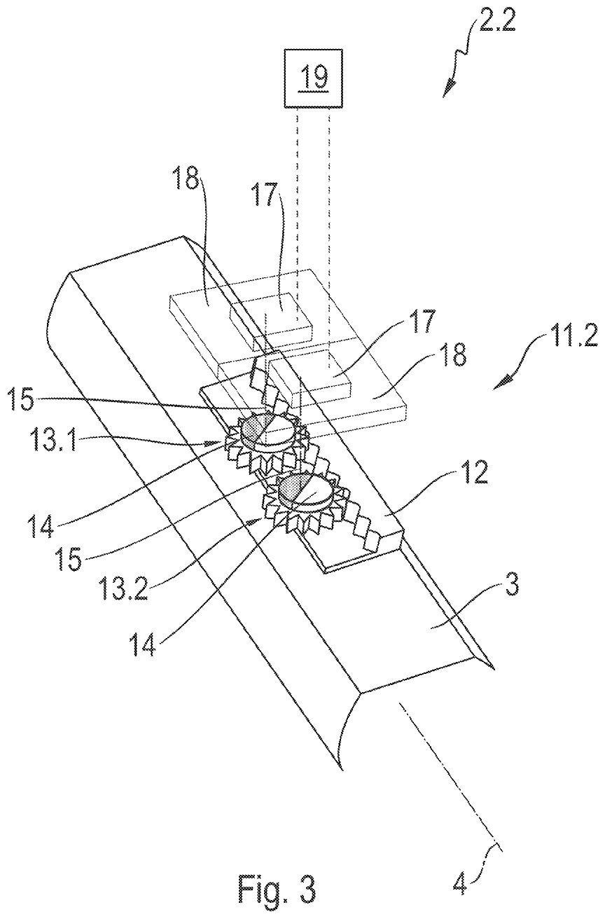

FIG. 3 shows a schematic, perspective detail of a second steering system 2.2 according to the disclosure, for example for the steer-by-wire steering 1 according to FIG. 1. Only a detail of the steering element 3 and a schematic illustration of constituent parts of one exemplary arrangement of the detection device 11 are illustrated here.

As distinct from the detection device 11.1 according to FIG. 2, the detection device 11.2 illustrated here has two detection gear wheels 13. Thus, the detection device 11.2 has a first detection gear wheel 13.1 with a first permanent magnet 14, and a second detection gear wheel 13.2 with a second permanent magnet 14. In this exemplary arrangement, the first detection gear wheel 13.1 and the second detection gear wheel 13.2 engage in the same rack section 12 at different positions. Here, the first detection gear wheel 13.1 and the second detection gear wheel 13.2 are rotatably mounted about their respective axis of rotation 15 without any contact with each other.

The two detection gear wheels 13 in this exemplary arrangement implement a redundancy function. To this end, the first detection gear wheel 13.1 is assigned a first magnetic sensor 17 for detecting the rotational position of the first detection gear wheel 13.1 and a first rotation counter 18 for detecting a number of revolutions of the first detection gear wheel 13.1. For the purpose of redundancy, the second detection gear wheel 13.2 is assigned a second magnetic sensor 17 for detecting the rotational position of the second detection gear wheel 13.2 and a second rotation counter 18 for detecting a number of revolutions of the second detection gear wheel 13.2.

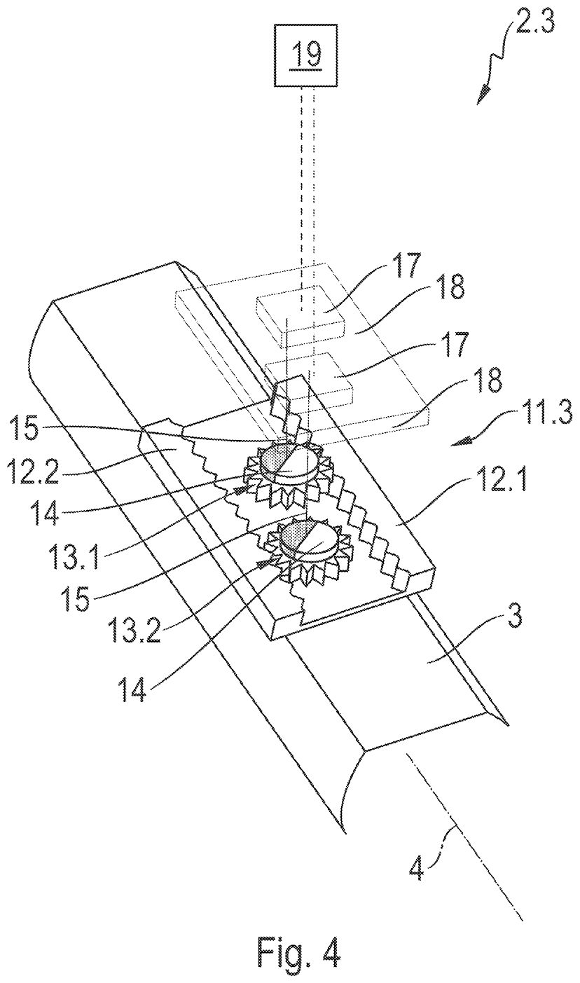

FIG. 4 shows a schematic perspective detail of a third steering system 2.3 according to the disclosure, for example for the steer-by-wire steering 1 according to FIG. 1. Only a detail of the steering element 3 and a schematic illustration of constituent parts of one exemplary arrangement of the detection device 11 are shown here.

As distinct from the detection device 11.2 according to FIG. 3, the detection device 11.3 illustrated here has two rack sections 12. Here, the first detection gear wheel 13.1 engages in the first rack section 12.1 and the second detection gear wheel 13.2 in a second rack section 12.2 formed independently of the first rack section 12.1.

In this exemplary arrangement, the first rack section 12.1 and the second rack section 12.2 are arranged opposite each other and mirror-symmetrically relative to each other. The two rack sections 12.1, 12.2 are spaced apart from each other at right angles to the central longitudinal axis 4 of the steering element 3. Thus, the two detection gear wheels 13.1, 13.2 are arranged between the two rack sections 12.1, 12.2. As a result, the two detection gear wheels 13.1, 13.2 rotate in different directions during a displacement of the steering element 3.

As in the detection device 11.2 according to FIG. 3, the detection device 11.3 illustrated here is also designed to implement a redundancy function. To this extent, reference is also made to the preceding description to avoid repetitions.

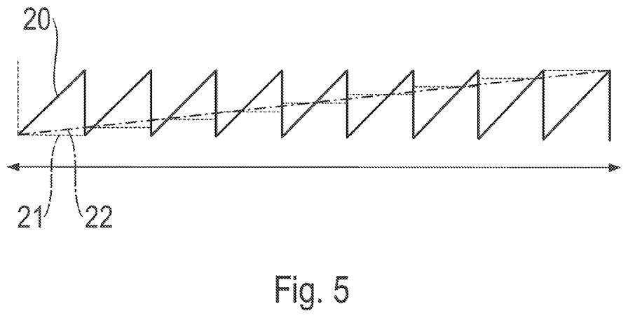

FIG. 5 shows a schematic waveform of signals 20, 21, 22 from the sensors 17, 18 of a detection device 11 for a steering system 2 according to one of FIG. 2, 3 or 4.

The magnetic sensor 17 provides the signal 20 and the rotation counter 18 the signal 21.

The signal 20 from the magnetic sensor 17 forms a sawtooth pattern, each tooth of the signal 20 corresponding to one rotation of the permanent magnet 14 through 360°. This means that the waveform of the signal 20 repeats at each complete revolution of the permanent magnet 14 and of the associated detection gear wheel 13.

The signal 21 from the rotation counter 18 forms a step pattern. Using the signal 21 from the rotation counter 18, it is thus possible to determine how many revolutions the permanent magnet 14 or the associated detection gear wheel 13 has made.

The revolutions are counted here with reference to a starting position of the permanent magnet 14 or of the associated detection gear wheel 13, the number of revolutions being counted up or counted down, depending on the direction of rotation.

Using the two signals, the evaluation and control unit 10 can calculate the signal 22 and therefore determine the absolute position of the permanent magnet 14, i.e. the 360° position, and the number of revolutions. This results in the signal 20 calculated for the determination of the absolute position as a linearly rising signal 20. From the signal 20, the evaluation and control unit 10 can in turn determine an accurate position of the steering element 3 and ultimately a steering angle implemented on the wheel 16.

The maximum possible number of revolutions of the permanent magnet 14 or the associated detection gear wheel 13 can be restricted in both directions of rotation, for example to a maximum of 35 revolutions. This restriction can result from the maximum travel of the steering element 3. When the maximum possible number of revolutions has been reached, a maximum steering angle has been set.

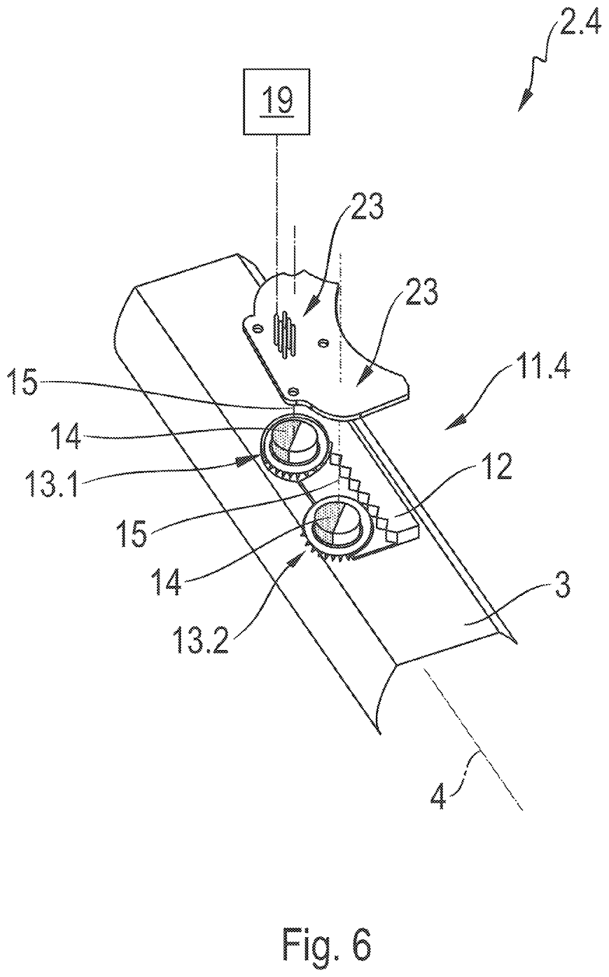

FIG. 6 shows a schematic perspective detail of a fourth steering system 2.4 according to the disclosure, for example for the steer-by-wire steering 1 according to FIG. 1. Only a detail of the steering element 3 and a schematic illustration of constituent parts of one embodiment of the detection device 11 are shown here.

In terms of the basic structure, the detection device 11.4 illustrated here is constructed similarly to the detection device 11.2 according to FIG. 3. Thus, the detection device 11.4 likewise has two detection gear wheels 13.1 and 13.2, which each have a permanent magnet 14. The first detection gear wheel 13.1 and the second detection gear wheel 13.2 engage in the same and single rack section 12 at different positions. Here, the first detection gear wheel 13.1 and the second detection gear wheel 13.2 are rotatably mounted about their respective axis of rotation 15 without any contact with each other.

However, in the detection device 11.4 illustrated here, what is known as the Vernier principle is implemented by the first detection gear wheel 13.1 and the second detection gear wheel 13.2. To this end, the two detection gear wheels 13.1 and 13.2 according to this exemplary arrangement are formed differently. The first detection gear wheel 13.1 is formed here differently from the second detection gear wheel 13.2 with regard to its external diameter and the number of teeth.

In this exemplary arrangement, each detection gear wheel 13.1 and 13.2 is respectively assigned a sensor device 23, not specifically illustrated here, for detecting the respective rotational angle. The respective sensor device 23 can be based, for example, on a magnetic, an inductive, a resistive and/or an optical operating principle. Thus, the respective sensor device 23 can each, for example, have a magnetic sensor 17 and a rotation counter 18 according to the preceding description. What is important for the implementation of the Vernier principle by means of the detection device 11.4 is that a phase difference is produced between the signals generated by the permanent magnets 14 of the two detection gear wheels 13.1 and 13.2, using which an absolute position of the steering element 3 can be determined.

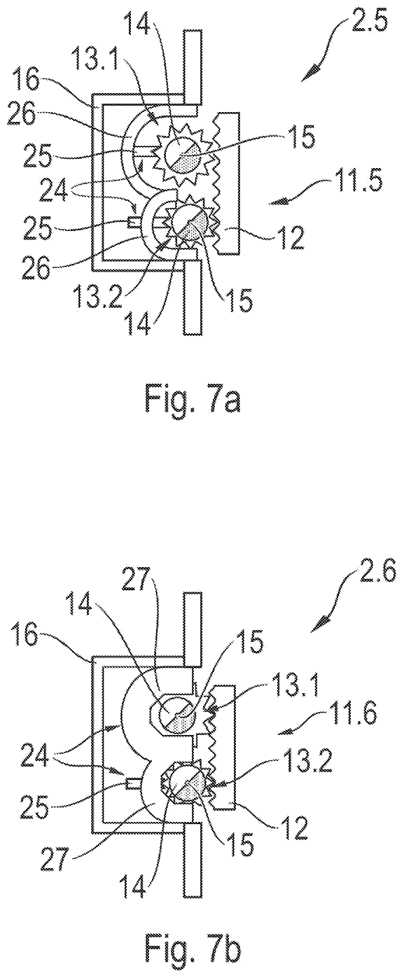

FIG. 7a shows a schematic top view of a fifth steering system 2.5 according to the disclosure, for example for the steer-by-wire steering 1 according to FIG. 1. Only a detail of schematically illustrated constituent parts of one exemplary arrangement of the detection device 11 is illustrated here. The steering element 3 is not illustrated, instead only a single rack section 12, which is firmly connected to the steering element 3.

The basic structure of the detection device 11.5 illustrated here is similar to the detection device 11.4 according to FIG. 6. Thus, the detection device 11.5 has two detection gear wheels 13.1 and 13.2, which each have a permanent magnet 14. Here, the two detection gear wheels 13.1 and 13.2 are formed differently to implement the Vernier principle. Alternatively, the detection gear wheels 13.1 and 13.2 can also be formed, however, as identical parts according to the detection device 11.3 according to FIG. 3.

The detection device 11.5 illustrated here has a guide device 24 to compensate for tolerances. Here, the detection gear wheels 13.1 and 13.2 are each displaceably mounted at right angles to the rack section 12 and thus to the central longitudinal axis 4 of the steering element 3 by means of the guide device 24. The guide device 24 has a guide groove 25 for each detection gear wheel 13.1 and 13.2. The guide groove 25 is oriented at right angles to the central longitudinal axis 4 of the steering element 3 and to the longitudinal extent of the rack section 12. In this exemplary arrangement, the respective axis of rotation 15 of the detection gear wheel 13.1 or 13.2 is linearly displaceably guided in the associated guide groove 25.

Furthermore, the guide device 24 in this exemplary arrangement has a spring element, not specifically illustrated here. Due to the spring element, the respective detection gear wheel 13.1 or 13.2 is preloaded and spring-mounted in the direction of the rack section 12. This ensures that the detection gear wheel 13.1 or 13.2 is always in toothed engagement with the rack section 12. At the same time, tolerances such as material tolerances, production tolerances and/or wear tolerances can be compensated.

The guide device 24 in this exemplary arrangement is formed as a constituent part of a housing 16, shown here only as a detail. Furthermore, according to this example, the housing 16 has a respective rotary holder 26 for the first detection gear wheel 13.1 and for the second detection gear wheel 13.2.

The rotary holders 26 are implemented as rigid, segment-shaped wall sections, the radius of these wall sections being correspondingly formed to receive an outer circumference of the respective detection gear wheel 13.1 or 13.2. The wall sections or the rotary holders 26 can be used as a stop for the guide device 24. The rotary holders 26 are formed here in such a way that, even in the event of contact with the respective detection gear wheel 13.1 or 13.2, these are rotatable about their respective axis of rotation 15.

FIG. 7b shows a schematic top view of a sixth steering system 2.6 according to the disclosure, for example for the steer-by-wire steering 1 according to FIG. 1. The steering system 2.6 and the detection device 11.6 illustrated here largely correspond to the steering system 2.5 and the detection device 11.5 according to FIG. 7a. To this extent, reference is also made to the preceding description to avoid repetitions.

As distinct from the exemplary arrangement according to FIG. 7a, the housing 16 according to this example has a respective rotary holder 27 for the first detection gear wheel 13.1 and for the second detection gear wheel 13.2. The rotary holders 26 according to FIG. 7a can likewise be implemented or omitted.

The rotary holders 27 are implemented as rigid polygonal wall sections, in this exemplary arrangement the polygonal contour of these wall sections being correspondingly formed to receive an outer circumference of the permanent magnet of the respective detection gear wheel 13.1 or 13.2. The wall sections or the rotary holders 27 can be used as a stop for the guide device 24. Here, the rotary holders 27 are formed in such a way that, even in the event of contact with the respective permanent magnet 14, here formed or enclosed in the manner of a disk, the detection gear wheels 13.1 and 13.2 are each rotatable about the respective axis of rotation 15.

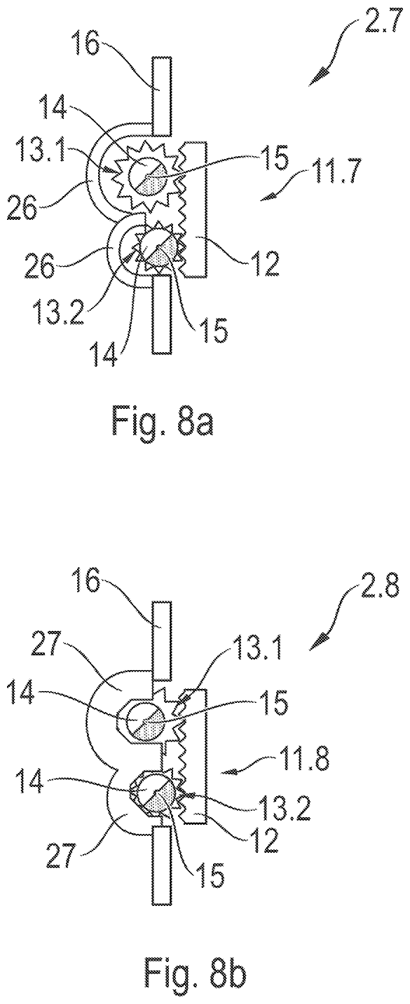

FIGS. 8a and 8b each show a schematic top view of a seventh steering system 2.7 according to the disclosure having a detection device 11.7, and a further steering system 2.8 having a detection device 11.8. These exemplary arrangements correspond largely to the steering system 2.5 and 2.6 and the detection device 11.5 and 11.6 according to FIGS. 7a and 7b. To this extent, reference is also made to the preceding description to avoid repetitions.

Differing from the exemplary arrangements according to FIGS. 7a and 7b, however, the exemplary arrangements illustrated here have no guide device 24, instead only the rotary holders 26 and 27.

1. A steering system for a vehicle comprising: a steering element, wherein the steering element is linearly displaceable in a longitudinal direction of a central longitudinal axis of the steering element, and having a detection device for detecting a position of the steering element, the detection device having at least one rack section extending parallel to the central longitudinal axis, wherein the rack section is linearly displaceable together with the steering element, and the detection device has at least one detection gear wheel and a permanent magnet is fastened to the detection gear wheel, wherein the detection gear wheel engages in the rack section.

2. The steering system as claimed in claim 1, wherein the steering element is displaceable relative to the detection gear wheel, and the detection device has a magnetic sensor for detecting a rotational position of the detection gear wheel and a rotation counter for detecting a number of revolutions of the detection gear wheel.

3. The steering system as claimed in claim 1, wherein an evaluation unit and/or a control unit is connected to the detection device, wherein a position of the steering element can be or is determined by the evaluation unit and/or the control unit using data signals obtained from, a magnetic sensor and a rotation counter, the detection device, the magnetic sensor and the rotation counter integrated in a common circuit.

4. The steering system as claimed in claim 1, wherein the rack section is formed as a one-piece constituent part of the steering element, or wherein the rack section is formed as an independent component, the rack section being firmly connected to the steering element.

5. The steering system as claimed in claim 1, wherein the detection device has a first detection gear wheel with a first permanent magnet, and a second detection gear wheel with a second permanent magnet.

6. The steering system as claimed in claim 5, wherein the first detection gear wheel and the second detection gear wheel engage in the same rack section at different positions.

7. The steering system as claimed in claim 5, wherein the first detection gear wheel engages in a first rack section, and the second detection gear wheel engages in a second rack section formed independently of the first rack section.

8. The steering system as claimed in claim 5, wherein, in order to implement a redundancy, the first detection gear wheel is assigned a first magnetic sensor for detecting a rotational position of the first detection gear wheel and a first rotation counter for detecting a number of revolutions of the first detection gear wheel, and the second detection gear wheel is assigned a second magnetic sensor for detecting the rotational position of the second detection gear wheel and a second rotation counter for detecting a number of revolutions of the second detection gear wheel.

9. The steering system as claimed in claim 5, wherein the Vernier principle is implemented by the first detection gear wheel and the second detection gear wheel, for which purpose the first detection gear wheel is designed differently from the second detection gear wheel, with regard to its external diameter and/or the number of teeth.

10. The steering system as claimed in claim 1, wherein the at least one detection gear wheel is displaceably mounted transversely or at right angles to the central longitudinal axis of the steering element by a guide device to compensate for tolerances, and wherein an axis of rotation of the detection gear wheel is linearly displaceably guided in at least one guide groove of the guide device, wherein the detection gear wheel is preloaded and/or spring-mounted in the direction of the rack section by a spring element of the guide device.

11. The steering system as claimed in claim 1, wherein the at least one detection gear wheel and/or an axis of rotation of the detection gear wheel is rotatably mounted and/or guided in an at least one rotary holder, wherein the rotary holder is formed as a constituent part of a housing, and wherein the rotary holder has a segment-like or polygonal contour.

12. A steer-by-wire steering with a steering system as claimed in claim 1.

13. The steering system as claimed in claim 2, wherein the detection gear wheel, the sensor and/or the rotation counter is assigned to a housing, wherein the steering element is displaceable relative to the housing.

14. The steering system as claimed in claim 13, wherein an axis of rotation of the detection gear wheel is connected to the housing.

15. The steering system as claimed in claim 2, wherein an evaluation unit and/or a control unit is connected to the detection device, wherein a position of the steering element can be or is determined by the evaluation unit and/or the control unit using data signals obtained from, a magnetic sensor and a rotation counter, the detection device, the magnetic sensor and the rotation counter being integrated in a common circuit.

16. The steering system as claimed in claim 3, wherein the rack section is formed as a one-piece constituent part of the steering element, or wherein the rack section is formed as an independent component, the rack section being firmly connected to the steering element.

17. The steering system as claimed in claim 5, wherein the first detection gear wheel and the second detection gear wheel are mounted in a housing so as to be rotatable relative to each other without contact, wherein the steering element is linearly displaceable relative to the housing.

18. The steering system as claimed in claim 6, wherein, in order to implement a redundancy, the first detection gear wheel is assigned a first magnetic sensor for detecting a rotational position of the first detection gear wheel and a first rotation counter for detecting a number of revolutions of the first detection gear wheel, and the second detection gear wheel is assigned a second magnetic sensor for detecting the rotational position of the second detection gear wheel and a second rotation counter for detecting a number of revolutions of the second detection gear wheel.

19. The steering system as claimed in claim 7, wherein, in order to implement a redundancy, the first detection gear wheel is assigned a first magnetic sensor for detecting a rotational position of the first detection gear wheel and a first rotation counter for detecting a number of revolutions of the first detection gear wheel, and the second detection gear wheel is assigned a second magnetic sensor for detecting the rotational position of the second detection gear wheel and a second rotation counter for detecting a number of revolutions of the second detection gear wheel.
